(19) United States
(12) Patent Application Publication
(10) Pub. No.: US 2007/0243826 A1
(43) Pub. Date: Oct. 18, 2007

(54) Testing apparatus and method for a multi-paths simulating system

(75) Inventor: I-Ru Liu, Taipei City (TW)

Correspondence Address: BIRCH STEWART KOLASCH & BIRCH, PO BOX 747, FALLS CHURCH, VA, 22040-0747, US

(73) Assignee: Accton Technology Corporation

(21) Appl. No.: 11/402,843

(22) Filed: Apr. 13, 2006

(51) Int. Cl. H04B 17/00

(52) U.S. Cl. 455/67.11

(57) ABSTRACT

An innovative testing apparatus and method for a multi-paths simulating system is proposed. The testing apparatus comprises a shielded chamber to avoid the external electromagnetic interference and other unexpected transmission paths. The multi-paths simulating system is utilized by attenuators for simulating a communication effects in a MIMO channel propagation environment. A control unit can set of MIMO and SISO modes of TD, RD and DUT to determine attenuation difference and downlink, uplink throughputs difference of the TD, RD and DUT.

### BACKGROUND OF THE INVENTION

1. Field of the Invention

The invention relates to a multi-paths simulating system, and more specifically, to a multiple input multiple output (MIMO) system with shielded anechoic chamber for avoiding the external electromagnetic interference and other unexpected transmission paths.

2. Description of the Prior Art

Applications such as mobile phone and wireless local area network (WLAN) had been more popular accompanying with well-developed of wireless communication technology. The application of incoming wireless metropolitan area network (WMAN) is expected to be the same. By comparison with real route signal transmission having fixed passing through path, transmission of wireless signal has the property of multi-paths. The multi-paths means that wireless signal propagates in space producing reflection in coinciding with obstacles such as wall, and therefore between the emitting terminals and the receiving terminals exist multiple paths wave propagation. For the receiving terminals, the above different multiple paths waves will create inter-symbol interference and fading effects owing to phase difference of the waves such that complexity and stability issue of signal receiving exist in multiple paths.

Moreover, in the conventional testing of wireless communication equipments such as mobile phone, wireless stations, network interface cards and access point, is performed on free space for simulating signal transmission of the products or devices under inaccurately controlling the testing conditions such that the testing outcomes of the products is doubtful and unreliable. Under such environments, external electromagnetic interface (EMI) and un-expected reflecting multi-paths will be produced, and the practical testing operation is inflexible due to space limitation. In addition, channel emulators for simulating the practical environments are adapted for cable modem testing system, and therefore it can not test antenna diversity performance of wireless communication equipments due to lack of antenna such that the channel emulators can not provide available and reliable testing reports and multiple input multiple output (MIMO) testing. Accordingly, a convenient and effective simulating the multiple paths and testing products performance in practical usage environments is desired to provide.

In view of the aforementioned, the present invention disclose a testing apparatus and method for a multi-paths simulating system to overcome the above drawbacks of external electromagnetic interference and other unexpected transmission paths generated in the conventional testing.

### SUMMARY OF THE INVENTION

The main object of the present invention is to disclose a testing apparatus and method for a multi-paths simulating system to overcome the issues of external electromagnetic interference and other unexpected transmission paths generated in the conventional testing.

The object of the present invention is to disclose a testing apparatus and method for a multi-paths simulating system to adapt for flexibly fitting SISO and different MIMO configurations, for example: 1×1, 1×2, 1×3, 1×4, 2×1, 2×2, 2×3, 2×4, 3×1, 3×2, 3×3, 3×4, 4×1, 4×2, 4×3, 4×4 . . . etc.

The another object of the present invention is to disclose a testing apparatus and method for a multi-paths simulating system to adapt for versatile to test different MIMO schemes which may determine Spatial Multiplexing (SM), Antenna Diversity (AD) and Beam Forming (BF) gain of the MIMO system.

The further advantages of the testing apparatus and method for a multi-paths simulating system of the present invention are simple control, less process time, easily to make calibration and low cost.

One aspect of the present invention is to provide a testing apparatus for a multi-paths simulating system comprising: multiple antennas disposed in a shielded chamber, wherein the multiple antennas include first antennas for coupling to a device under test and second antennas coupled to a reference device; attenuators coupled to a testing device and third antennas; phase-shifters coupled to corresponding third antennas and the attenuators; and a control unit coupled to the device under test, the reference device, the testing device and the attenuators wherein the control unit is utilized to control attenuation of the third antennas and operation mode of the device under test, reference device and the testing device, respectively.

The testing apparatus further comprises an absorber disposed in the shielded chamber for blocking line of sight (LOS) rays. The attenuators, such as programmable attenuators are driven by an attenuator driver coupled to the control unit.

The spacing and squint angles among the first, second and third antennas are adjustable with each other. For example, the device under test comprises station or AP, and the reference device and testing device comprise golden station or AP.

A further aspect of the invention is to provide a testing method for a multi-paths simulating system, comprising: setting a testing device coupled to first antennas and a reference device coupled to second antennas to the same MIMO mode, wherein the first antennas and second antennas are disposed in a shielded chamber; setting attenuators and phase-shifters to reference settings to get some required RSSIs of the testing device and reference device; and adjusting the attenuators, phase-shifters, spacing, squint angle and polarization crossing of the first antennas and second antennas to acquire relatively highest downlink and/or uplink first throughputs of the testing device and reference device.

The testing method further comprises disposing an absorber in said shielded chamber for blocking LOS rays.

The testing method further comprises setting the reference device to SISO mode; determining relatively highest downlink and/or uplink second throughputs of the testing device and the reference device; and decreasing the attenuation of the attenuators such that the first throughputs substantially equal to the second throughputs between the MIMO mode with the SISO mode.

The testing method further comprises setting a device under test to the same MIMO mode; setting the attenuators and phase-shifters to some reference settings to get required RSSIs of the testing device and device under test; and adjusting the attenuators, phase-shifters, spacing, squint angle and polarization crossing of the first antennas and second antennas to acquire relatively highest downlink and/or uplink third throughputs of the testing device and device under test.

The testing method further comprises setting the device under test to SISO mode; determining relatively highest downlink and/or uplink fourth throughputs of the testing device and device under test; and decreasing the attenuation of the attenuators such that the third throughputs substantially equal to the fourth throughputs between the MIMO mode with the SISO mode.

### BRIEF DESCRIPTION OF THE DRAWINGS

For a better understanding of the present invention and to show how it may be carried into effect, reference will now be made to the following drawings, which show the preferred embodiments of the present invention, in which:

FIG. 1 shows a communication MIMO system.

FIG. 2 shows a testing apparatus for a multi-paths simulating system according to a preferred embodiment of the present invention.

FIG. 3 shows a flow chart of testing method for a multi-paths simulating system with setting the same MIMO mode of the testing device and reference device according to the present invention.

FIG. 4 shows a flow chart of testing method for a multi-paths simulating system with setting SISO mode of the reference device according to the present invention.

FIG. 5 shows a flow chart of testing method for a multi-paths simulating system with setting the same MIMO mode of the testing device and device under test according to the present invention.

FIG. 6 shows a flow chart of testing method for a multi-paths simulating system with setting SISO mode of the device under test according to the present invention.

### DESCRIPTION OF THE PREFERRED EMBODIMENTS

The present invention includes testing apparatus and method for a multi-paths simulating system in a communication system. In the following description, numerous specific details are set forth in order to provide a thorough understanding of the present invention, and the scope of the present invention is expressly not limited expect as specified in the accompanying claims. One skilled in the relevant art will recognize, however, that the invention may be practiced without one or more of the specific details. In other instances, well known structures, materials, or operations are not shown or described in order to avoid obscuring aspects of the invention.

Those of ordinary skill in the art will immediately realize that the embodiments of the present invention described herein in the context of methods and schematics are illustrative only and are not intended to be in any way limiting. Other embodiments of the present invention will readily suggest themselves to such skilled persons having the benefits of this disclosure.

This invention relates to a testing apparatus and method for a multi-paths simulating system to enable supporting for IEEE 802.11 a/b/g testing, especially IEEE 802.11 n testing.

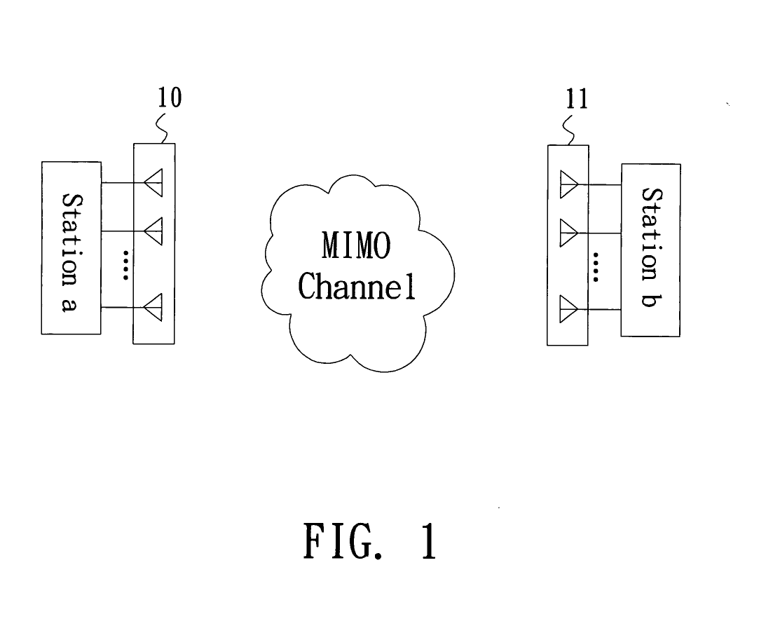

The schematic shown in FIG. 1 comprises two communication stations a and b. The station a utilizes multiple antennas 10 coupled to the station a communicating with multiple antennas 11 coupled to the station b through the MIMO channel, i.e. propagation environment of the multiple antennas 10 and 11. In general, MIMO multi-paths effects are to be evaluated by six main performances while doing spatial multiplexing, antenna diversity or beam forming in antenna mode. The above six performances comprise transmit-signal maximum output power refer to transmit antenna output, i.e. Effective Isotropic Radiated Power (EIRP), receive-signal sensitivity referring to receive antenna input, i.e. System Sensitivity (SS), uplink throughput and packet loss rate, downlink throughput and packet loss rate, latency and Jitter of upload-service and latency and Jitter of download-service. In other words, those performances are definitely influenced by the parameters of multiplexing gain, diversity gain or beam forming gain.

The above-mentioned diversity gain is determined by the following equation:
Diversity Gain=(Ideal Diversity Gain)×(1−ρ)^{(1/2)},
where the Ideal Diversity Gain is proportional to the dimensions n×m, n or m, wherein m is for transmit diversity gain, n for receive diversity gain, n×m for total system diversity gain, and correlation coefficient ρ is a function of the following parameters: separated antenna patterns (angular separation), separated antenna positions (spatial separation), isotropic distribution of incoming multi-paths waves (angular spread) and wide-dispersive distribution of incoming multi-paths waves (delay spread). Moreover, the multiplexing gain is related to the correlation coefficient ρ as well, except that the Ideal Multiplexing Gain is rather proportional to the dimension m or n, whichever is less in the system.

Next, beam-forming gain, i.e. phase-comparison or amplitude-comparison array gain is proportional to the Ideal Beam-forming Gain which is related to the dimensions n×m, n or m, wherein m is for transmit beam-forming gain, n for receive beam-forming gain, n×m for total system beam-forming gain, and conditionally related to the correlation coefficient ρ, since the followings:
1. in some cases the space distribution of incoming multi-paths waves is limited and fixed in path rather than wide-dispersive or of opportunity in time, and therefore the individual antennas have better to have in-phase waveforms to raise the combined gain; and
2. in the same cases as above, the angle distribution of incoming multi-paths waves is limited and fixed in direction rather than isotropic or of opportunity in angle, and therefore the individual antennas have better to have identical patterns to raise the combined gain; in addition
3. the span of antenna spacing or squint-angles should be adjusted and traded off to get the balance between accuracy and ambiguity of direction determining by phase-comparison or amplitude-comparison.

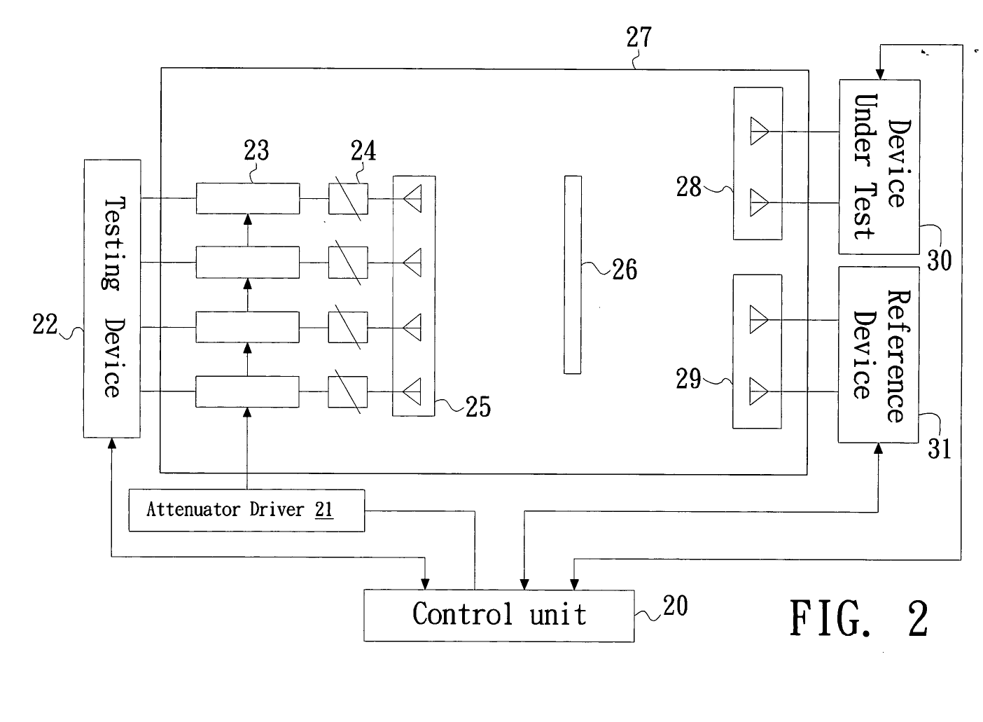

FIG. 2 shows a testing apparatus for a multi-paths simulating system according to a preferred embodiment of the present invention. The multi-paths simulating system is utilized for simulating a communication effects in a MIMO channel simulating environment. The multi-paths simulation of the present comprises attenuation or phase-shift emulation. The MIMO system may comprise Single-Input Multiple-Output (SIMO) system or Multiple-Input Single-Output (MISO) system. The testing apparatus comprises multiple testing antennas 25, multiple under test antennas 28 and multiple reference antennas 29 disposed in a shielded chamber 27, attenuators 23, absorber 26 and phase-shifters 24. The antennas 28 are coupled to a device under test (DUT) 30. The antennas 29 are coupled to a reference device (RD) 31. The attenuators 23 are coupled to a testing device (TD) 22. The phase-shifters 24, such as manual-control phase-shifters, are coupled to the antennas 25 and the attenuators 23. The absorber 26 is disposed in the shielded chamber 27 to absorb for blocking line of sight (LOS) rays. The attenuators 23, such as programmable attenuators are driven by an attenuator driver 21 respectively. For example, the attenuator driver 21 comprises an attenuator switch driver for switching the attenuators 23. A control unit 20 is coupled to the device under test 30, reference device 31, testing device 22 and the attenuator driver 21. For example, the spacing, squint angles and polarization crossing among the antennas 25, 28 and 29 can be manually adjusted by some mechanism. In one embodiment, the device under test 30 comprises station or access point (AP), and the reference device 31 and testing device 22 may comprise golden station or AP.

For example, the shielded chamber 27 is utilized by a big size shielded chamber to evaluate performance for engineering test in laboratory, and utilized by a small size shielded enclosure to check function for manufacturing test in factor. Moreover, the shielded chamber 27 of the present invention has the followings properties:
1. There is test range within the inner space of EM wave shielded chamber or enclosure;
2. The inner space emulates MIMO environment to some accepted degree;
3. The chamber or enclosure are not anechoic but reflective to provide bouncing rays which disperses in lengths and directions to emulate enough delay and angle spreads;
4. LOS rays should be blocked in the chamber or enclosure;
5. The rays with shortest length in shielded chamber or enclosure had better (though is hard in reality to) be kept being longer than (2×D²)/λ to assure it is built by radiating far-field, where D is the largest dimension of notebook, personal computer or AP, λ is the smallest operating wavelength;
6. Shielded enclosure has more times of bouncing then has smaller dimensions than shielded chamber does.

The testing device 22 produces a signal equally distributing into multi-paths simulating signals and passing to the attenuators 23 for attenuating the multi-paths simulating signals. The attenuators 23 simulate wireless communication signals attenuation on transmitting process in transmission environment. In general, higher degree of signals attenuation indicates that the signals can reach larger transmission range in transmission environment. In one embodiment, every one of the attenuators 23 are driven by an attenuator driver 21 controlled by the control unit 20. Therefore, attenuation of the multi-paths simulating signals produced by the testing device 22 can be controlled by the control unit 20. The phase-shifters 24 may convert the phase of every one of the multi-paths signals respectively. Moreover, by setting the attenuators 23 controlled by the control unit 20 and adjusting phase-shifters 24 to some reference settings can get required received signal strength indicators (RSSIs) of the testing device 22, reference device 31 and device under test 30. In other words, the control unit 20 can monitor RSSIs of the TD 22, RD 31 and DUT 30 and downlink and uplink throughputs of the TD 22, RD 31 and DUT 30.

Then, the antennas 25 are utilized to transmit the multi-paths signals. The reference device 31 and the device under test 30 may receive the multi-paths signals through the antennas 29, 28 respectively. The control unit 20 may control the reference device 31 and the device under test 30 to determine which one is performed testing and related testing mode, such as single input single output (SISO) or MIMO mode. Next, by adjusting the attenuators 23, phase-shifters 24, spacing, squint angle and polarization crossing of the antennas 25, 28 and 29 can acquire relatively highest downlink and/or uplink throughputs of the testing device 22, device under test 30 and the reference device 31. Moreover, by decreasing the attenuation of the attenuators 23 such that SISO mode throughputs substantially equal to MIMO mode throughputs can determine the attenuation difference between the MIMO mode with SISO mode. In other words, the control unit 20 can execute the analysis of throughput differences and link-quality enhancement of different testing modes, and the analysis of attenuation difference and MIMO gain, such as SM, AD or BF gain, implying to signal-quality enhancement in dB.

In one embodiment, the control unit 20 comprises notebook, personal computer executing integrally unit providing for DUT 30, TD 22 and RD 31 client controller, DUT 30, TD 22 and RD 31 server controller or attenuator 23, emulator controller.

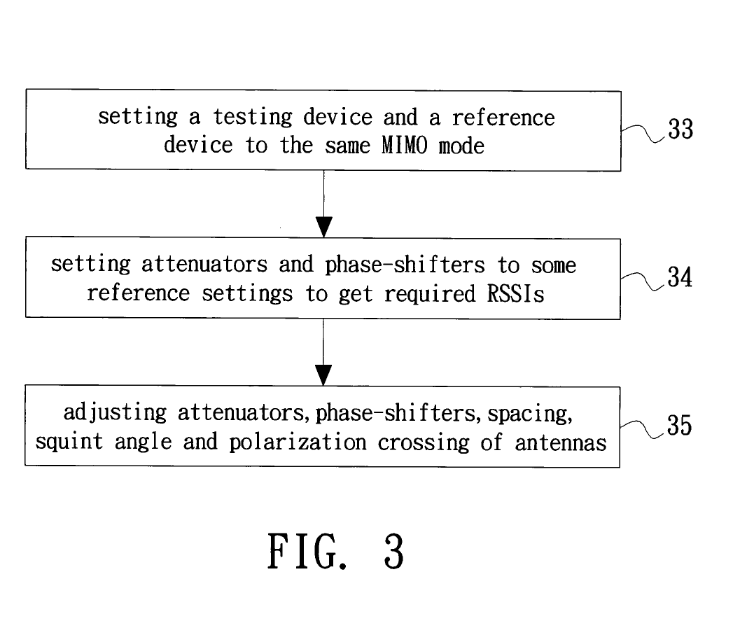

FIG. 3 shows a flow chart of testing method for a multi-paths simulating system according to the present invention. In reference number 33, the first step of the simulating testing process of the present invention is setting a testing device 22 and a reference device 31 to the same MIMO mode. The testing device 22 and reference device 31 may place in the opposite positions of the shielded chamber 27. Next, in reference number 34, the step is performed to equally set the attenuators 23 and phase-shifters 24 to some reference settings to get required RSSIs of the testing device 22 and reference device 31. Subsequently, in reference number 35, the step is to adjust the attenuators 23, phase-shifters 24, spacing, squint angle and polarization crossing of the antennas 25, 29 to acquire relatively highest downlink and/or uplink first throughputs of the testing device 22 and reference device 31. In other words, this step is executed by back and forth for adjusting spacing and squint angle of antenna 25, 29 and optionally adjusting polarization crossing of the antenna 25 of the testing device 22, referring to spacing, squint angle of the specific antenna 29 and optionally adjusting polarization crossing of the antenna 29 of the reference device 31 and optionally fine-tune individual attenuators 23 and phase-shifters 24 such that both or either of downlink and uplink throughputs approach to maxima, that is, correlation coefficient ρ approaches to minimum.

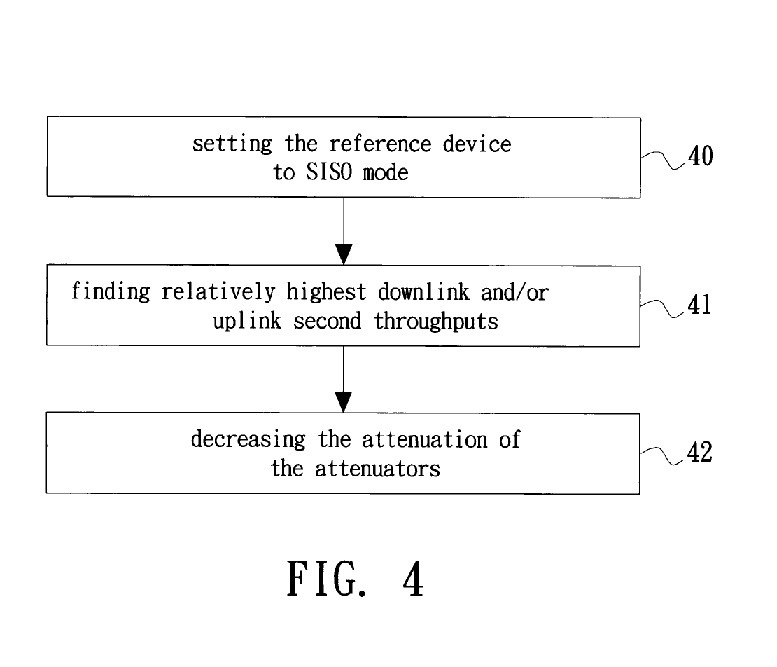

FIG. 4 shows a flow chart of testing method for a multi-paths simulating system with setting SISO mode of the reference device according to the present invention. In reference number 40, the subsequent step of the simulating testing process of the present invention is executed setting the reference device 31 to SISO mode. Next, in reference number 41, the step is performed to determine relatively highest downlink and/or uplink second throughputs of the testing device 22 and reference device 31. In other words, this step is executed to determine both or either of downlink and uplink throughputs to approach the values substantially equal to the maxima got by MIMO mode. Then, throughputs difference of MIMO mode referring to SISO mode is determined, and the result may give to the MIMO link-quality enhancement of the reference device 31 relative to the testing device 22. Subsequently, in reference number 42, the step is performed to decrease equally the attenuation of the attenuators 23 such that the first throughputs substantially equal to the second throughputs between the MIMO mode with the SISO mode. In other words, this step is executed to decrease equally the attenuation of attenuators 23 of the testing device 22 such that both or either of downlink and uplink throughputs approaches to the values equal to the maxima got by MIMO mode. Then, attenuation difference in dB of MIMO mode with of SISO mode is determined, and the result may give to the MIMO gain, such as SM, AD, or BF gain, of the reference device 31 relative to the testing device 22.

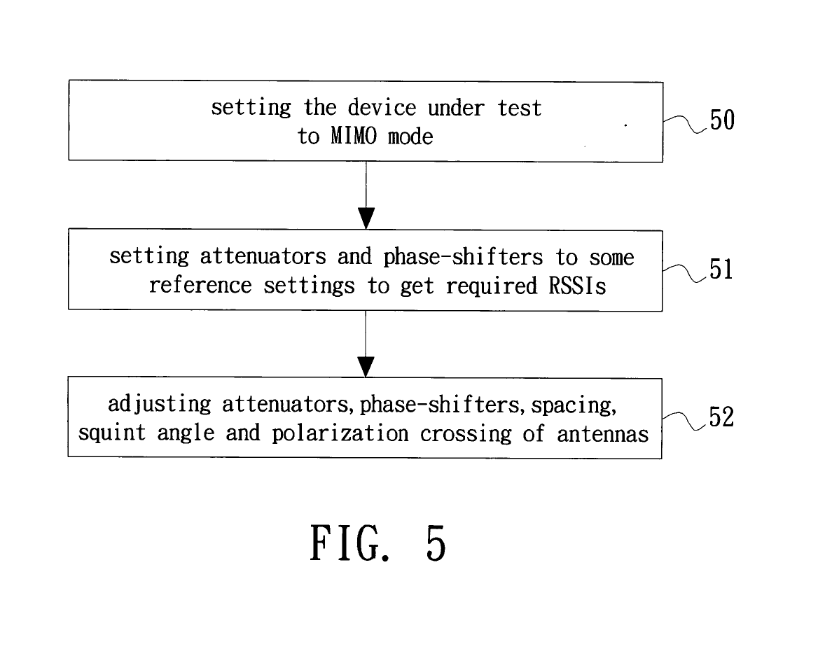

FIG. 5 shows a flow chart of testing method for a multi-paths simulating system with setting the same MIMO mode of the testing device and device under test according to the present invention. In reference number 50, the step is performed setting a testing device 22 and a device under test 30 to the same MIMO mode. The testing device 22 and device under test 30 may place in the opposite positions of the shielded chamber 27. Similarly, in reference number 51, the step is performed equally setting attenuators 23 and phase-shifters 24 to some reference settings to get required RSSIs of the testing device 22 and device under test 30. Subsequently, in reference number 52, the step is performed for adjusting the attenuators 23, phase-shifters 24, spacing, squint angle and polarization crossing of the antennas 25, 28 to acquire relatively highest downlink and/or uplink third throughputs of the testing device 22 and device under test 30. In other words, this step is executed by back and forth to adjust spacing and squint angle of antenna 25, 28 and optionally adjusting polarization crossing of the antenna 25 of the testing device 22, referring to spacing, squint angle of the specific antenna 28 and optionally adjusting polarization crossing of the antenna 28 of the device under test 30 and optionally fine-tune individual attenuators 23 and phase-shifters 24 such that both or either of downlink and uplink throughputs approach to maxima.

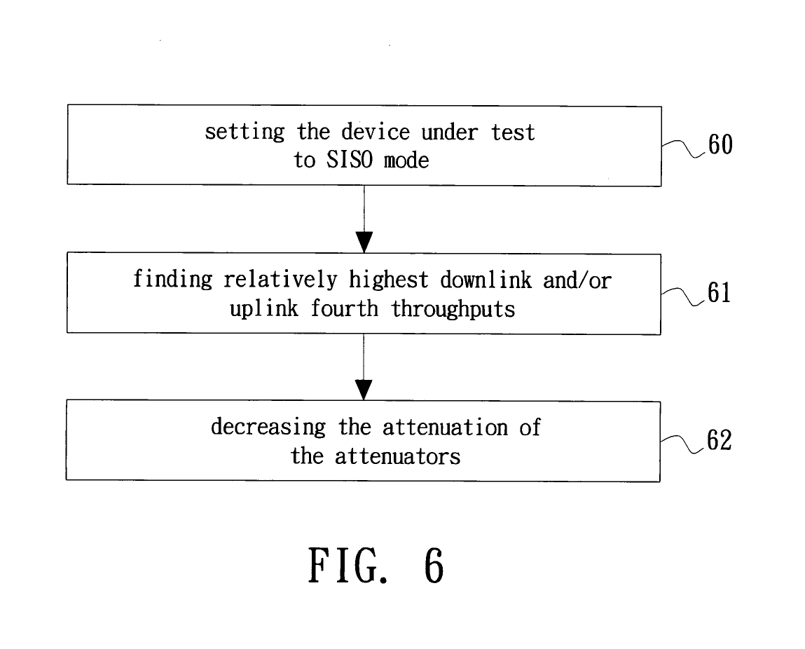

FIG. 6 shows a flow chart of testing method for a multi-paths simulating system with setting SISO mode of the device under test according to the present invention. In reference number 60, the subsequent step is performed setting the device under test 30 to SISO mode. Next, in reference number 61, the step is performed to determine relatively highest downlink and/or uplink fourth throughputs of the testing device 22 and device under test 30. In other words, this step is executed to determine both or either of downlink and uplink throughputs to approach the values substantially equal to the maxima got by the above MIMO mode. Similarly, throughputs difference of MIMO mode referring to SISO mode can be determined, and the result may give to the MIMO link-quality enhancement of the device under test 30 relative to the testing device 22. Subsequently, in reference number 62, the step is executed decreasing equally the attenuation of the attenuators 23 such that the third throughputs substantially equal to the fourth throughputs between the MIMO mode with the SISO mode. In other words, this step is executed to decrease equally the attenuation of attenuators 23 of the testing device 22 such that both or either of downlink and uplink throughputs approaches to the values equal to the maxima got by the MIMO mode. Then, attenuation difference in dB of MIMO mode with of SISO mode can be determined, and the result may give to the MIMO gain of the device under test 30 relative to the testing device 22. The attenuation difference indicates antenna's gain.

To summarize, the test utility in the control unit 20 of the present invention can execute the following acts to complete the above-mentioned procedure of testing process for multi-paths simulating system:
1. Setting of MIMO and SISO modes of TD 22, RD 31 and DUT 30;
2. Setting of attenuation of TD 22;
3. Monitoring RSSIs of TD 22, RD 31 and DUT 30;
4. Monitoring downlink and uplink throughputs of TD 22, RD 31 and DUT 30;
5. Analysis of throughput differences in percentage and link-quality enhancement; and
6. Analysis of attenuation difference and MIMO gain (implying to signal-quality enhancement) in dB.

Furthermore, an absorber 26 may be disposed in the shielded chamber 27 for blocking LOS rays to enhance the simulating effects.

In conclusion, we have proposed a testing apparatus and method for a multi-paths simulating system to overcome the issues of external electromagnetic interference and other unexpected transmission paths generated in the conventional testing. The proposed system is simple control, less process time and does not need complicated calibration. With the advantages of available for flexibly fitting SISO and different MIMO configurations and versatile to test different MIMO schemes, the present system will dramatically reduce the cost.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A testing apparatus for a multi-paths simulating system, comprising:
multiple antennas disposed in a shielded chamber, wherein said multiple antennas include first antennas for coupling to a device under test and , second antennas coupled to a reference device;
attenuators coupled to a testing device and third antennas; and
a control unit coupled to said device under test, said reference device, said testing device and said attenuators.

2. The testing apparatus of claim 1, wherein said multi-paths simulating system comprises MIMO system.

3. The testing apparatus of claim 1, further comprising phase-shifters coupled to corresponding said third antennas and said attenuators.

4. The testing apparatus of claim 3, wherein said phase-shifters comprises manual-control phase-shifter.

5. The testing apparatus of claim 1, further comprising an absorber disposed in said shielded chamber for blocking LOS rays.

6. The testing apparatus of claim 1, further comprising an attenuator driver coupled to said attenuators and control unit, wherein said attenuator driver is controlled by said control unit.

7. The testing apparatus of claim 6, wherein said attenuator driver comprises an attenuator switch driver.

8. The testing apparatus of claim 1, wherein said attenuators comprises programmable attenuators.

9. The testing apparatus of claim 1, wherein said device under test comprises station or AP.

10. The testing apparatus of claim 1, wherein said reference device and said testing device comprise golden station or AP.

11. A testing apparatus for a multi-paths simulating system, comprising:
multiple antennas disposed in a shielded chamber, wherein said multiple antennas include first antennas for coupling to a device under test and second antennas coupled to a reference device;
attenuators coupled to a testing device and third antennas; and
a control unit coupled to said device under test, said reference device, said testing device and said attenuators, wherein said control unit is utilized to control attenuation of said third antennas and operation mode of said device under test, said reference device and said testing device, respectively.

12. The testing apparatus of claim 11, wherein said multi-paths simulating system comprises MIMO system.

13. The testing apparatus of claim 11, further comprising phase-shifters coupled to corresponding said third antennas and said attenuators.

14. The testing apparatus of claim 13, wherein said phase-shifters comprises manual-control phase-shifter.

15. The testing apparatus of claim 11, further comprising an absorber disposed in said shielded chamber for blocking LOS rays.

16. The testing apparatus of claim 11, further comprising an attenuator driver coupled to said attenuators and control unit, wherein said attenuator driver is controlled by said control unit.

17. The testing apparatus of claim 16, wherein said attenuator driver comprises an attenuator switch driver.

18. A testing method for a multi-paths simulating system, comprising:
setting a testing device coupled to first antennas and a reference device coupled to second antennas to the same MIMO mode, wherein said first antennas and said second antennas are disposed in a shielded chamber;
setting attenuators and phase-shifters to reference settings to get a RSSIs of said testing device and said reference device; and
adjusting said attenuators, said phase-shifters, spacing, squint angle and polarization crossing of said first antennas and said second antennas to acquire relatively highest downlink and/or uplink first throughputs of said testing device and said reference device.

19. The testing method of claim 18, further comprising disposing an absorber in said shielded chamber for blocking LOS rays.

20. The testing method of claim 18, further comprising:
setting said reference device to SISO mode;
determining relatively highest downlink and/or uplink second throughputs of said testing device and said reference device; and
decreasing the attenuation of said attenuators such that said first throughputs substantially equal to said second throughputs between said MIMO mode with said SISO mode.

21. The testing method of claim 18, further comprising:
setting a device under test to said MIMO mode;
setting said attenuators and said phase-shifters to reference settings to get a RSSIs of said testing device and said device under test; and
adjusting said attenuators, said phase-shifters, spacing, squint angle and polarization crossing of said first antennas and said second antennas to acquire relatively highest downlink and/or uplink third throughputs of said testing device and said device under test.

22. The testing method of claim 21, further comprising:
setting said device under test to SISO mode;
determining relatively highest downlink and/or uplink fourth throughputs of said testing device and said device under test; and
decreasing the attenuation of said attenuators such that said third throughputs substantially equal to said fourth throughputs between said MIMO mode with said SISO mode.
